(19) United States
(12) Patent Application Publication
(10) Pub. No.: US 2006/0239754 A1
(43) Pub. Date: Oct. 26, 2006

(54) Utility Clip For Utilitarian Tools

(76) Inventor: Dan L. Dietz, Houston, TX (US)

Correspondence Address: Jimmy Mark Gilbreth, P. O. Box 2428, Bellaire, TX, 77402-2428, US

(21) Appl. No.: 10/907,919

(22) Filed: Apr. 21, 2005

(51) Int. Cl. B43K 29/00; B43K 23/02

(52) U.S. Cl. 401/131; 401/195

(57) ABSTRACT

A holder for utilitarian tools having a holder body, which defines one docks for receiving a writing instrument, and another dock for receiving a flashlight. The writing instrument and flashlight are secured in place using a magnetic coupling mechanism. The hold further includes a clip for securing the holder to another object, for example, a shirt pocket.

### BACKGROUND OF THE INVENTION

The present invention relates to a utility holder, to methods of securing, and to tool sets. In another aspect, the present invention relates to a utility holder for tools, to methods of securing such tools, to a tool set comprising such a holder with tools. In even another aspect, the present invention relates to a utility holder for securing tools thereto using magnetic engagement, methods of securing such tools using magnetic engagement, and to tool sets comprising such holder with tools. In still another aspect, the present invention relates to a utility holder for elongated tools, to methods of securing such tools, and to tool sets comprising such holders with tools. In yet another aspect, the present invention relates to a utility holder for securing a writing instrument and/or a flashlight, to methods of securing a writing instrument and/or a flashlight, and to a tool set comprising the holding having secured thereto a writing instrument and flashlight.

Very commonly, writing instruments are provided with a clip, generally a resilient metal or plastic piece that is biased against the body of the writing instrument, which is used to secure the writing instrument in a pocket or against any other object.

Similarly, pen shaped lights, may also be equipped with such a clip. Other elongated tools, non-limiting examples of which include screw driver, level, and fuse/circuit tester, may also be equipped with such a clip.

There are a number of patents directed to clips for holding pens, the following of which are merely a few.

U.S. Pat. No. 352,554, issued on Apr. 25, 1992, to Min-Jenn, discloses a writing board for attachment to a vehicle sun visor. A clip for holding a writing instrument is shown.

U.S. Pat. No. 397,073, issued on Aug. 18, 1998, to Kui, discloses Visor Mirror with Notepad and Pen. The ornamental design for a visor mirror with notepad and pen, as shown.

U.S. Pat. No. 3,140,781, issued on Jul. 14, 1964, to Rothgart, discloses a combination mirror and holder. This invention relates to mirrors for mounting on the sun visor of an automotive vehicle or similar mounting member.

U.S. Pat. No. 3,016,262, issued on Jan. 9, 1962, to Hunt, discloses an automobile sun visor accessory. This invention relates to automobile accessories and more particularly ro an accessory adapted to be attached to the sun visor of an automobile.

U.S. Pat. No. 5,558,429, issued on Sep. 24, 1996, to Cain, discloses a portable lighting device. A portable light is provided which is operated and turned on automatically when the light is moved to a vertical or near vertical position and turns off automatically when in a non-vertical position. A highly reliable, sealed a reed switch is operated when an associated magnet moves into proximity. A locking mechanism retains the magnet to prevent operation of the light when not in use. A manually operated, mechanical switch is also provided and uses a metal strip to over ride the magnet/reed switch to allow for selective operation of the light in any position. The light can be used as a flashlight or attached to a cooler lid, car hood, visor attache case and the like to turn on automatically as the attached, hinged device is moved to a vertical or near vertical position.

U.S. Pat. No. 2,297,806, issued on Oct. 6, 1942, to Smith, discloses a magnetic holder for pencils or the like. This invention relates to holders for utilitarian instrumentalities such as pencils, pens and the like and has for an object to provide means for attaching a pencil to and supporting the pencil form various articles in a manner whereby said pencil is readily disposed to the hand of a user and readily detachable from said article for use.

U.S. Pat. No. 2,644,212, issued on Jul. 7, 1953, to Markowitz, discloses a magnetic holder for pencils. This invention relates to new and useful improvements in magnetic holders or attachments for pencils and other articles, and, more particularly, to improvements on and additions to the magnetic pencil holder disclosed in co-pending application filed on Aug. 22, 1950, Ser. No. 180,733.

U.S. Pat. No. 2,913,789, issued on Nov. 24, 1959, to Loredo, discloses a pen and pencil Holder. The present invention relates to new and useful improvements in pencil and pen holders and has its primary object to provide, in a manner as hereinafter set forth, novel means for mounting such writing instruments on the outside of a shirt or pocket, ready for convenient use at all times.

U.S. Pat. No. 2,964,812, issued on Dec. 20, 1950, to Cook, discloses a magnetic pencil clip. This invention relates to a magnetic clip and more particularly to a pencil clip which can support a pencil in the usual clip manner or can support the pencil on a metal surface by magnetic attraction.

U.S. Pat. No. 3,178,784, issued on Apr. 20, 1965, to Krauthamer, discloses a magnetic pocket pencil holder. This invention relates generally to devices for supporting writing instruments and the like and more particularly to a magnetized device for supporting a pencil, pen and the like, on a pocket of an article of clothing.

U.S. Pat. No. 4,865,285, issued on Sep. 12, 1989, to Gaggianesse, discloses a magnetic penholder and magnetic pen set. A magnetic penholder and magnetic pen set which comprises a base (1) with magnet (5) therein with one magnetic pole facing upwards. Pen (2) includes a magnet (8) therein which is attracted by the magnet (5) of the base, so that the pen will rotate until an opposite pole is exposed. The curved surface of the base provides substantially a point area of contact between the base and pen.

In spite of the above holders for utilitarian tools, there still exists the need for improved holders for utilitarian tools, for methods of securing such tools, and to tool sets comprising holders with such tools.

In spite of the above holders for writing instruments, there still exists the need for improved holders for writing instruments, methods of securing such writing instruments, and to tool sets comprising such holders with writing instruments.

These and other needs of the art will become apparent to those of ordinary skill in the art upon review of this specification and drawings.

### SUMMARY OF THE INVENTION

It is an object of the present invention to provide for improved holder, methods of securing such tools, and to tool sets.

It is another object of the present invention to provide for improved holders, methods of securing such writing instruments, and to tool sets comprising such holders with writing instruments.

These and other objects of the present invention will become apparent to those of ordinary skill in the art upon review of this specification and drawings.

According to one embodiment of the present invention, there is provided a holder for utilitarian tools. The holder includes a holder body defining a first dock having a dock shape suitable for receiving a first utilitarian tool, and a second dock having a dock shape suitable for receiving a second utilitarian tool. The holder also includes a magnet supported by the holder body and positioned to simultaneously magnetically couple with a first utilitarian tool when the first utilitarian tool is positioned in the first dock, and with a second utilitarian tool when the second utilitarian tool positioned in the second dock. The holder also includes a clip supported by the body and adapted to anchor the holder body to an object.

According to another embodiment of the present invention, there is provided a utilitarian tool set. The tool set comprises the above described holder having a first utilitarian tool positioned in the first dock, and a second utilitarian tool positioned in the second dock.

According to even another embodiment of the present invention, there is provided a method for securing a first utilitarian tool and a second utilitarian tool to the above described holder. The method includes positioning the first utilitarian tool in the first dock sufficient to magnetically couple the first utilitarian tool to the magnetic coupling system, and then positioning the second utilitarian tool in the second dock sufficient to magnetically couple the first utilitarian tool to the magnetic coupling system.

According to still another embodiment of the present invention, there is provided a holder for utilitarian tools. The holder includes a holder body defining a first dock having a dock shape suitable for receiving a first utilitarian tool, and a second dock having a dock shape suitable for receiving a second utilitarian tool. The holder also includes a first magnet supported by the holder body and positioned to magnetically couple with a first utilitarian tool when the first utilitarian tool is positioned in the first dock. The holder also includes a second magnet supported by the holder body and positioned to magnetically couple with a second utilitarian tool when the second utilitarian tool is positioned in the second dock. The holder also includes a clip supported by the body and adapted to anchor the holder body to an object.

According to yet another embodiment of the present invention, there is provided a utilitarian tool set comprising the above described holder having a first utilitarian tool positioned in the first dock, and a second utilitarian tool positioned in the second dock.

According to even still another embodiment of the present invention, there is provided a method for securing a first utilitarian tool and a second utilitarian tool to the above described holder. The method includes positioning the first utilitarian tool in the first dock sufficient to magnetically couple the first utilitarian tool to the first magnetic coupling system, and positioning the second utilitarian tool in the second dock sufficient to magnetically couple the first utilitarian tool to the second magnetic coupling system.

### BRIEF DESCRIPTION OF THE DRAWINGS

Like reference numbers refer to like items in the drawings.

FIG. 1 is a side view of utility holder 100 of the present invention showing clip 104 affixed to holder body 120, with holder body 120 defining a first dock 130 and a second dock 150, with magnetic coupling member 105 positioned in magnetic coupling member recess 122.

FIG. 2 is a top view of utility holder 100 of FIG. 1 showing holder body 120 defining a first dock 130 and a second dock 150.

FIG. 3 is an isometric view of utility holder 100 of FIG. 1 showing clip 104 affixed to holder body 120, with holder body 120 defining a first dock 130 and a second dock 150, with magnetic coupling member 105 positioned in magnetic coupling member recess 122.

FIG. 4 is an end view of utility holder 100 of FIG. 1 showing clip 104 affixed to holder body 120, first dock end 130A and second dock end 150A.

FIG. 5 is an exploded isometric view of utility holder 100 of FIG. 1 showing clip 104, holder body 120, with holder body 120 defining a first dock 130 and a second dock 150, and magnetic coupling member 105.

FIG. 6 is a top view of utility holder 100 of FIG. 1 showing a writing instrument 43 positioned in second dock 150 and a flashlight positioned in first dock 130.

### DETAILED DESCRIPTION OF THE INVENTION

The utility holder of the present invention generally includes a holder body defining one or more docks in which a utilitarian tool is securely positioned. Preferably, the holder body defines at least two docks for securing tools, more preferably at least three docks. A tool set of the present invention comprises the holder of the present invention with at least one utilitarian tool secured to the holder.

A utilitarian tool may be secured in the dock by employing any suitable securing apparatus or method.

As a non-limiting example, the dock could be designed so that at least a portion of the tool will friction fit with the dock sufficient to be secured.

As another non-limiting example, the dock and the tool could be provided with mating locking mechanism, non-limiting examples of which include mating connectors, mating snaps, or hook and loop connectors.

Preferably however, a tool is secured in the dock by magnetic coupling. For the magnetic coupling system of the present invention, at least one of the dock or tool is provided with a magnet (first part of the magnetic coupling system), with the other of the dock or tool either also being provided with a magnet or a ferrous metal non-magnetic portion that will magnetically couple with a magnet (second part of the magnetic coupling system). Preferably, both the dock and the tool are provided with a magnet.

It should be understood that more than one type of securing apparatus or method may be utilized. For example, where the holder is provided with more than one dock, the docks may utilize the same or different types of securing apparatus or methods. As another example, a dock may utilize any combination of type of securing apparatus or methods. Where a combination is utilized, it is preferred to use magnetic coupling combined with friction fit.

It should be understood that a tool will be secured in the dock to the extent needed for the desired application to which the holder will be subjected. For example, lower vibration, lower impact, or low criticality applications will not require as much of a secured fit as would higher vibration, higher impact, or higher criticality applications. Thus, a holder to be clipped to a rider in a cross-country motor cycle race would have to more securely hold tools, as compared to a holder to be clipped to a jacket pocket of a pedestrian.

The utility holder of the present invention also includes an anchor mechanism for securing the holder to another object. Generally, this anchor may employ any suitable type of apparatus and method which will anchor the utility holder to another object. Non-limiting examples of suitable docks include mating connectors, magnetic coupling, and a clip. Preferable, the utility holder of the present invention is equipped with a clip for clipping the utility holder to another object.

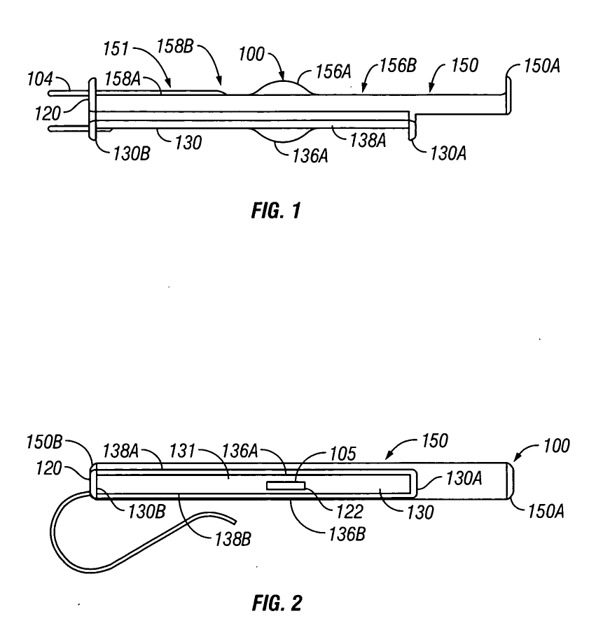

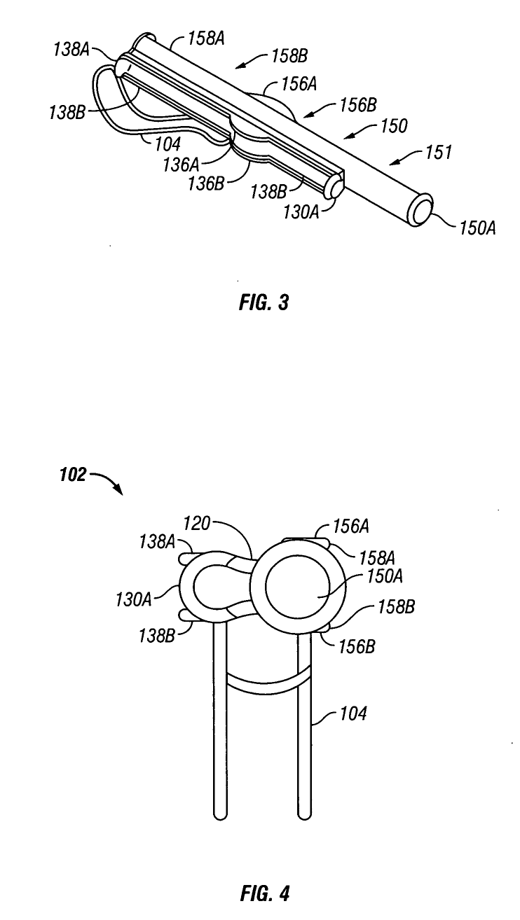

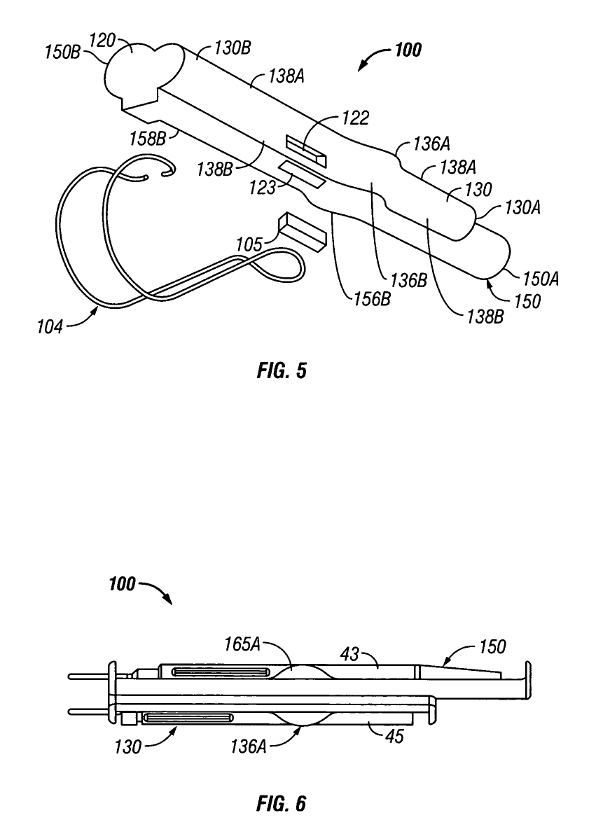

Referring now to FIGS. 1-6, there is shown one embodiment of utility holder 100 of the present invention.

FIG. 1 is a side view of utility holder 100 of the present invention showing clip 104 affixed to holder body 120, with holder body 120 defining a first dock 130 and a second dock 150, with magnetic coupling member 105 positioned in magnetic coupling member cavity 122.

Other views of utility holder 100 of FIG. 1 are provided in FIGS. 2-5, which show a top view, isometric view, end view and exploded view, respectively.

In the embodiment as shown, utility holder body 120 defines a first dock 130 and a second dock 150. This utility holder body 120 may be made of any suitable material as known, non-limiting examples of which include metals, plastics (thermoplastics or thermosets), naturally occurring materials, and composite materials, utilizing any suitable manufacturing method. Preferable, body 120 will comprise plastic and will be injection molded.

It should be understood that first dock 130 and second dock 150 have the same elements, although not all of the elements of second dock 150 are shown. Additionally, the various elements of first dock 130 have been numbered in the 130's whereas the various elements of second dock 150 have been numbered in the 150's with a value 20 higher. Thus, a first dock 130 element will have a three digit reference number of 1-3-N, wherein N is the units value of the three digit number, and the corresponding element for second docket 150 will have a reference number of 1-5-N. Thus, a discussion of first dock 130 regarding its elements in the 130's is to be understood as also applying to second dock 150 and its elements in the 150's.

While these docks have been pictured with first dock 130 having a smaller diameter and a shorter length than second dock 150, it should be understood that these docks may be of the same or different dimensions. It should also be understood that the dock dimensions will generally be dictated by the desire end use of utility holder 100. In the embodiment of utility holder 100 as shown, first dock 130 has been designed to receive a certain flashlight, and second dock 150 has been designed to receive a certain writing instrument.

It should also be understood that although holder body 120 is illustrated as having two docks, it may also comprise any desired number of docks as may be geometrically configured. While it is preferred that holder body 120 comprise 2 docks, it may also include at least 3 docks, at least 4 docks, and at least 5 docks.

The shape of first dock 130 and second dock 150 against which the tool will abut will generally be selected to efficiently receive the tools to be docked, and to aid securing the tool. For example, interior docking wall 131 of first dock 130 against which the tool will dock is shown as having a concave curvilinear shape against which a convex circularly shaped portion of flashlight 45 will abut. If interior wall 131 were instead shaped flat, then circularly shaped flashlight 45 would be predisposed to roll or move and would be as secure. A flat shaped interior docking wall 131 would be more suitable for a flashlight having a flat abutting surface.

A tool residing in first dock 130 will be magnetically coupled with member 105. This magnetic coupling will occur in a linear fashion between the tool and member 105. This magnetic coupling is weakest in direction in a plane normal to this linear coupling, that is, longitudinally along first dock 130. Thus, the most likely accidental loss of a docket tool would come from any jarring or impact of holder 100 or of the docked tool that would cause movement docket tool in a plane normal to the linear magnetic coupling, that is, rotational, lateral or longitudinal movement in a plane normal to the linear magnetic coupling direction. For example, for two magnets coupled together, the easiest way to get them apart is the slide them apart along this above mentioned normal plane.

Mating a concave shape of abutting wall 131 with a convex portion of a docked tool will certainly urge against some or all movement in a plane normal to the linear magnetic coupling direction, depending upon the design, position and number of such mating concave/convex shapes. Of course, it should be understood that a concave portion of the tool could be mated to a convex portion of abutting wall 131. It should also be understood that abutting wall 131 may comprise both convex and concave portions which can be mated to corresponding concave and convex portions of the docket tool.

To guard against movement of a docked tool in that normal plane, first dock 130 may also include other optional walls to further define first dock 130.

To guard against lateral movement in the plane normal to the linear magnetic coupling direction, first dock 130 may optionally include retaining walls 138A and 138B, which serve to prevent lateral movement of a docket tool past those retaining walls. Those retaining walls 138A and 138B may optionally include docking guide members 136A and 136B, respectively, which serve to guide a tool into first dock 130, and if positioned sufficiently close together, and provided with a certain amount of resilience, may also serve to provide a friction fit to further secure a tool in first dock 130. An optional friction fit may also be provided by positioning retaining walls 138A and 138B sufficiently close together, and providing them with a certain amount of resilience.

To guard against longitudinal movement in a plane normal to this magnetic attraction, first dock 130 may also be provided with end retaining walls 130A and 130B to prevent longitudinal movement of any docket tool. An optional friction fit may also be provided by positioning end retaining walls 130A and 130B sufficiently close together, and providing them with a certain amount of resilience. End retaining wall 130A and/or 130B may be provided with an aperture, made transparent, or have a transparent portion, to allow a flashlight to provide light there through. Light could then be directed by anchoring holder 100 with clip 104 as desired.

In a similar fashion, second dock 150 may optionally be provided with retaining walls 150A, 150B, 158A, 158B, and docking guides 156A and 156B.

Utility holder 100 is provided with a magnetic coupling system for securing tools in first dock 130 and second dock 150. Member 105 is inserted thru passage 123 and positioned in magnetic member cavity 122. Of course, member 105 may be molded into holder body 120 in a manner to make it integral to holder body 120. Member 105 is positioned between first dock 130 and second dock 150 in a manner to allow member 105 to simultaneously magnetically couple with tools positioned in both first dock 130 and second dock 150 (and with any other docks).

Of course while each of first dock 130 and second dock 150 may be equipped with its own dedicated member 105, it is preferred to utilize one member 105 strategically positioned between them (and any other additional docks as may be provided). Member 105 may be eliminated by utilizing a holder body 120 that is either magnetic or a magnetically attractive material, such as a ferrous material, that will magnetically couple with a docked tool.

In the practice of the present invention, each dock may be provided with one or more dedicated members 105. Alternatively, two or more docks may share one or more members 105.

While one or both ends of magnetic member cavity 122 may be sealed, preferably, magnetic member cavity 122 is open to both first dock 130 and second dock 150 to allow member 105 to be closely positioned to and preferably abutted against tools in those docks 130 and 150. If magnetic member cavity 122 is to be sealed, the sealing wall is preferably as thin as possible to allow for a close approach of member 105 with docked tools.

The utility holder 100 of the present invention also includes an anchor mechanism for securing to the holder to another object, which is clip 104 in the embodiment as shown in the figures. This clip 104 is most conveniently any suitable clip as is known in the art.

Referring to FIG. 6 there is shown top view of utility holder 100 of FIG. 1 showing a writing instrument 43 positioned in second dock 150 and a flashlight positioned in first dock 130.

While the present invention has been illustrated mainly by reference to securing only certain utilitarian instruments, specifically, a writing instrument and/or a light, it should be understood that any type of elongated utilitarian tool may be secured utilizing the present invention. Examples of such elongated tools include, screw driver, fuse/circuit tester, ruler, writing instruments, thermometer, level, straight edge, knife, telescoping tools such as a pointer.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

What is claimed is:

1. A holder for utilitarian tools comprising:
a holder body defining a first dock having a dock shape suitable for receiving a first utilitarian tool, and a second dock having a dock shape suitable for receiving a second utilitarian tool;
a magnet supported by the holder body and positioned to simultaneously magnetically couple with a first utilitarian tool when the first utilitarian tool is positioned in the first dock, and with a second utilitarian tool when the second utilitarian tool positioned in the second dock; and,
a clip supported by the body and adapted to anchor the holder body to an object.

2. The holder of claim 1, wherein the first dock and the second dock comprise retaining walls.

3. The holder of claim 1, wherein the first dock is shaped to provide a friction fit with the first utilitarian tool, and the second dock is shaped to provide a friction fit with the second utilitarian tool.

4. The holder of claim 1, wherein the first dock is shaped suitable for receiving a writing instrument, and the second dock is shaped suitable for receiving a flashlight.

5. A utilitarian tool set comprising:
a holder body defining a first dock having a dock shape suitable for receiving a first utilitarian tool, and a second dock having a dock shape suitable for receiving a second utilitarian tool;
a first utilitarian tool positioned in the first dock;
a second utilitarian tool positioned in the second dock;
a first part of a magnetic coupling system supported by the holder body and positioned to simultaneously magnetically couple with a first second part of the magnetic coupling system on the first utilitarian tool, and with a second second part of the magnetic coupling system on the second utilitarian tool; and,
a clip supported by the body and adapted to anchor the holder body to an object.

6. The set of claim 5, wherein the first utilitarian tool is a writing instrument, and the second utilitarian tool is a flashlight.

7. The set of claim 5, wherein the first part of the magnetic coupling system comprises a magnet.

8. A method for securing a first utilitarian tool and a second utilitarian tool to a holder, wherein the holder comprises a holder body defining a first dock having a dock shape suitable for receiving a first utilitarian tool, a second dock having a dock shape suitable for receiving a second utilitarian tool, and wherein the holder further comprises a magnetic coupling system supported by the holder body, the method comprising:
positioning the first utilitarian tool in the first dock sufficient to magnetically couple the first utilitarian tool to the magnetic coupling system;
positioning the second utilitarian tool in the second dock sufficient to magnetically couple the first utilitarian tool to the magnetic coupling system.

9. A holder for utilitarian tools comprising:
a holder body defining a first dock having a dock shape suitable for receiving a first utilitarian tool, and a second dock having a dock shape suitable for receiving a second utilitarian tool;
a first magnet supported by the holder body and positioned to magnetically couple with a first utilitarian tool when the first utilitarian tool is positioned in the first dock;
a second magnet supported by the holder body and positioned to magnetically couple with a second utilitarian tool when the second utilitarian tool is positioned in the second dock; and,
a clip supported by the body and adapted to anchor the holder body to an object.

10. The holder of claim 9, wherein the first dock and the second dock comprise retaining walls.

11. The holder of claim 9, wherein the first dock is shaped to provide a friction fit with the first utilitarian tool, and the second dock is shaped to provide a friction fit with the second utilitarian tool.

12. The holder of claim 9, wherein the first dock is shaped suitable for receiving a writing instrument, and the second dock is shaped suitable for receiving a flashlight.

13. A utilitarian tool set comprising:
a holder body defining a first dock having a dock shape suitable for receiving a first utilitarian tool, and a second dock having a dock shape suitable for receiving a second utilitarian tool;
a first utilitarian tool positioned in the first dock;
a second utilitarian tool positioned in the second dock;
a first part of a first magnetic coupling system supported by the holder body and positioned to magnetically couple with a second part of the first magnetic coupling system on the first utilitarian tool;
a first part of a second magnetic coupling system supported by the holder body and positioned to magnetically couple with a second part of the second magnetic coupling system on the second utilitarian tool; and,
a clip supported by the body and adapted to anchor the holder body to an object.

14. The set of claim 13, wherein the first utilitarian tool is a writing instrument, and the second utilitarian tool is a flashlight.

15. The set of claim 13, wherein the first part of the first magnetic coupling system comprises a first magnet, and wherein the second part of the second magnetic coupling system comprises a second magnet.

16. A method for securing a first utilitarian tool and a second utilitarian tool to a holder, wherein the holder comprises a holder body defining a first dock having a dock shape suitable for receiving a first utilitarian tool, a second dock having a dock shape suitable for receiving a second utilitarian tool, and wherein the holder further comprises first and second magnetic coupling system supported by the holder body, the method comprising:
positioning the first utilitarian tool in the first dock sufficient to magnetically couple the first utilitarian tool to the first magnetic coupling system;
positioning the second utilitarian tool in the second dock sufficient to magnetically couple the first utilitarian tool to the second magnetic coupling system.
